(19) United States
(12) Patent Application Publication
(10) Pub. No.: US 2025/0294449 A1
(43) Pub. Date: Sep. 18, 2025

(54) DISCOVERY OF POWER DEGRADED MODES IN A GREEN ELASTIC NETWORK

(71) Applicant: Cisco Technology, Inc., San Jose, CA (US)

(72) Inventors: Eduard Schornig, Haarlem (NL); Jean-Philippe Vasseur, Combloux (FR); Pierre-André Savalle, Rueil-Malmaison (FR); Grégory Mermoud, Venthône (CH)

(73) Assignee: Cisco Technology, Inc., San Jose, CA (US)

(21) Appl. No.: 18/608,543

(22) Filed: Mar. 18, 2024

(51) Int. Cl. H04W 52/02

(52) U.S. Cl. CPC H04W 52/0212; H04W 52/0274

(57) ABSTRACT

In one implementation, a device obtains data regarding a networking entity in a computer network and a set of possible configurations for the networking entity. The device determines a power degraded mode of the networking entity comprising one or more configurations from the set of possible configurations. The device estimates an amount of energy savings associated with activating the power degraded mode of the networking entity. The device causes the power degraded mode of the networking entity to be activated based on the amount of energy savings estimated by the device.

### TECHNICAL FIELD

The present disclosure relates generally to computer networks, and, more particularly, to the discovery of power degraded modes in a green elastic network.

### BACKGROUND

In recent years, the global landscape has been marked by an escalating demand for green initiatives, such as reducing energy consumption across various industries. This is due to factors such as climate change and an overall push towards operational efficiency. However, these efforts also come at a time when networking technologies and their associated resource demands are experiencing unprecedented growth, largely fueled by the digital transformation of economies, the proliferation of cloud services, and the roll out of next-generation networks, such as 5G cellular networks.

Traditionally, networks have attempted to meet their increasing user demands, while still meeting their service level agreements (SLAs), by overprovisioning. Under this strategy, the network capacity is significantly expanded in anticipation of future growth and/or bursts of demand. While doing so simplifies network design and operation, it also results in inefficiencies from a green perspective, as overprovisioning also means that the resources of a network will remain idle for extended periods of time, thereby consuming more energy than actually needed.

The ability to elastically scale a network to conserve energy while still ensuring that it provides acceptable performance is premised on prior knowledge of the various power degraded modes of the equipment in the network. However, discovering the capabilities of each of these devices can be too cumbersome for a team of network administrators to achieve, especially in large-scale networks that include thousands of devices or more.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example of a software defined network (SDN) implementation;

FIG. 5 illustrates an example of a cloud network architecture;

FIG. 6 illustrates an example of a network traffic usage time series;

FIG. 7 illustrates an example architecture to implement an artificial intelligence (AI)-driven elastic network to reduce energy consumption;

FIG. 8 illustrates an example of the interactions of the components of FIG. 7 in an AI-driven elastic network;

FIG. 9 illustrates an example architecture for the discovery of power degraded modes in a green elastic network; and

FIG. 10 illustrates an example simplified procedure for the discovery of power degraded modes in a green elastic network.

### DESCRIPTION OF EXAMPLE IMPLEMENTATIONS

### Overview

According to one or more implementations of the disclosure, a device obtains data regarding a networking entity in a computer network and a set of possible configurations for the networking entity. The device determines a power degraded mode of the networking entity comprising one or more configurations from the set of possible configurations. The device estimates an amount of energy savings associated with activating the power degraded mode of the networking entity. The device causes the power degraded mode of the networking entity to be activated based on the amount of energy savings estimated by the device.

Other embodiments are described below and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

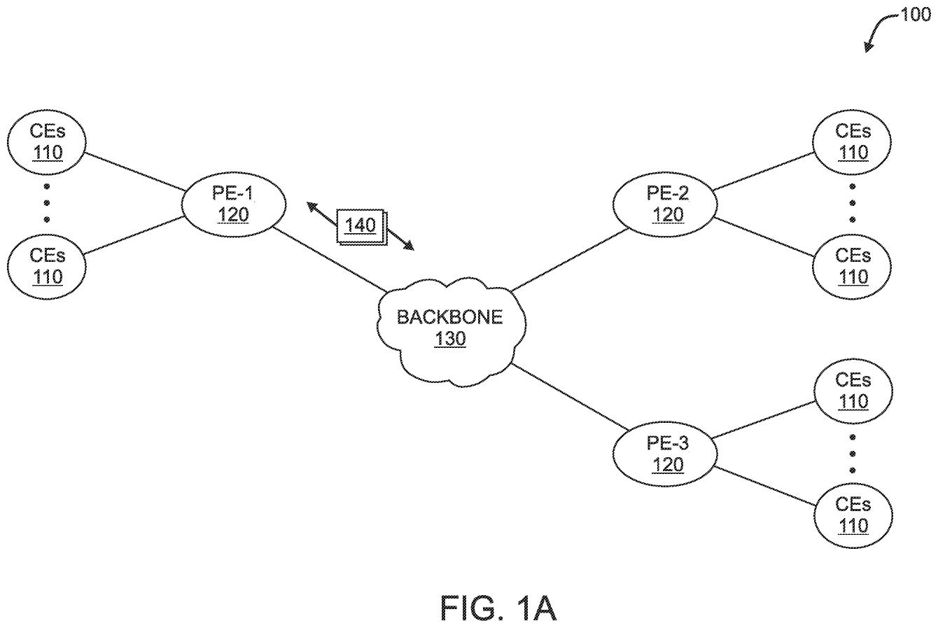

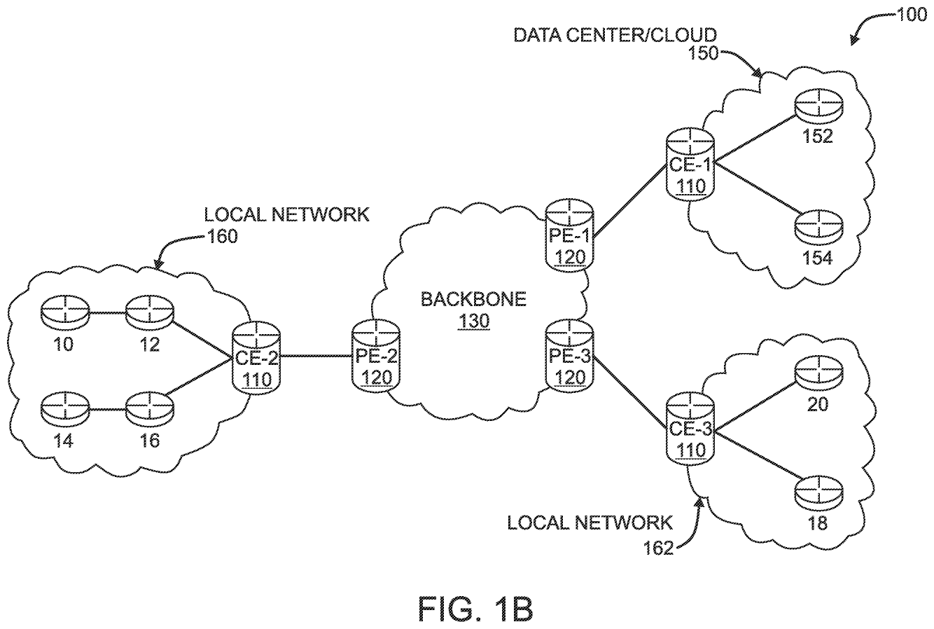

FIG. 1A is a schematic block diagram of an example computer network (e.g., network 100) illustratively comprising nodes/devices, such as a plurality of routers/devices interconnected by links or networks, as shown. For example, customer edge (CE) routers (e.g., router 110) may be interconnected with provider edge (PE) routers 120 (e.g., PE-1, PE-2, and PE-3) in order to communicate across a core network, such as an illustrative network backbone (e.g., network backbone 130). For example, router 110, router 120 may be interconnected by the public Internet, a multiprotocol label switching (MPLS) virtual private network (VPN), or the like. Data packets 140 (e.g., traffic/messages) may be exchanged among the nodes/devices of the computer network (e.g., network 100) over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router (e.g., router 110) shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement (SLA), whereas Internet links may either have no SLA at all or a loose SLA (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router (e.g., router 110) connected to PE-2 and a second CE router (e.g., router 110) connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local and/or branch networks that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

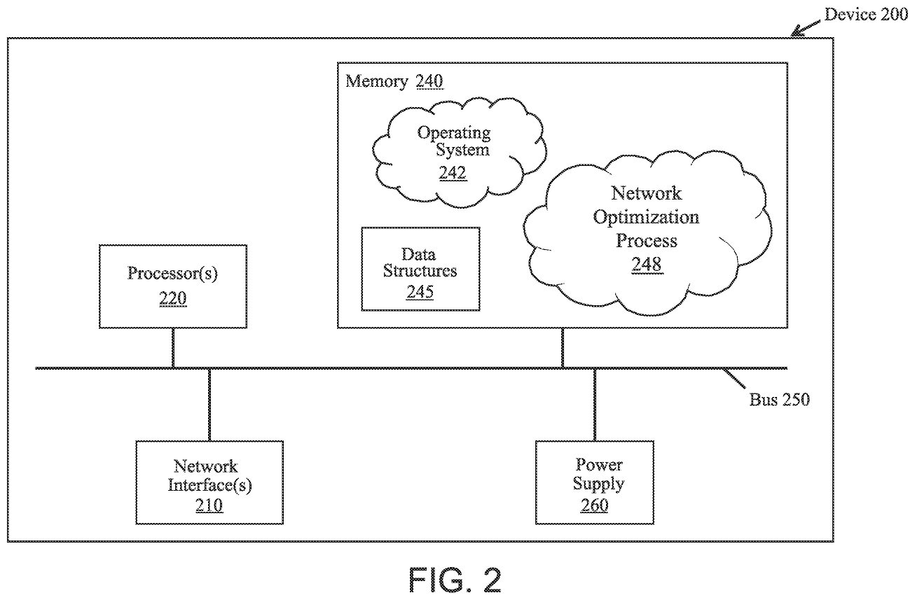

FIG. 2 is a schematic block diagram of an example node/device 200 (e.g., an apparatus) that may be used with one or more implementations described herein, e.g., as any of the computing devices shown in FIGS. 1A-1B, particularly the PE routers (e.g., router 120), CE routers (e.g., router 110), nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces (e.g., network interfaces 210), one or more processors (e.g., processor(s) 220), and a memory 240 interconnected by a system bus 250 and powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, network optimization process 248 may include computer executable instructions that, when executed by processor(s) 220, cause device 200 to perform the techniques described herein. To do so, in some implementations, network optimization process 248 may utilize machine learning. In general, machine learning is concerned with the design and the development of techniques that take as input empirical data (such as network statistics and performance indicators) and recognize complex patterns in these data.

In various implementations, network optimization process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that network optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, network optimization process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, network optimization process 248 may use a generative model to generate synthetic network traffic based on existing user traffic to test how the network reacts. Example generative approaches can include, but are not limited to, generative adversarial networks (GANs), large language models (LLMs), other transformer models, and the like.

As noted above, in software defined WANs (SD-WANs), traffic between individual sites is sent over tunnels. The tunnels are configured to use different switching fabrics, such as MPLS, Internet, 4G or 5G, etc. Often, the different switching fabrics provide different quality of service (QOS) at varied costs. For example, an MPLS fabric typically provides high QoS when compared to the Internet but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Typically, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is often performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

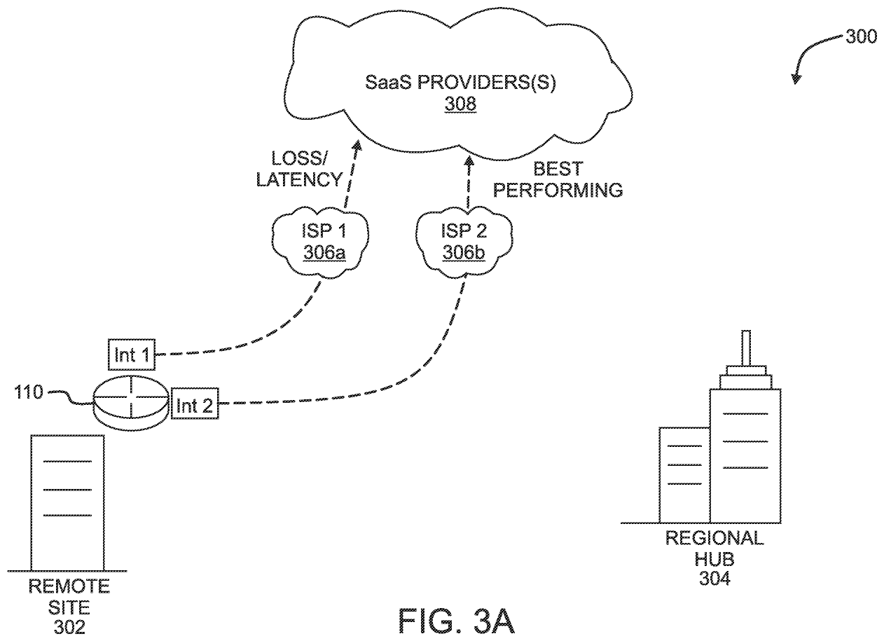

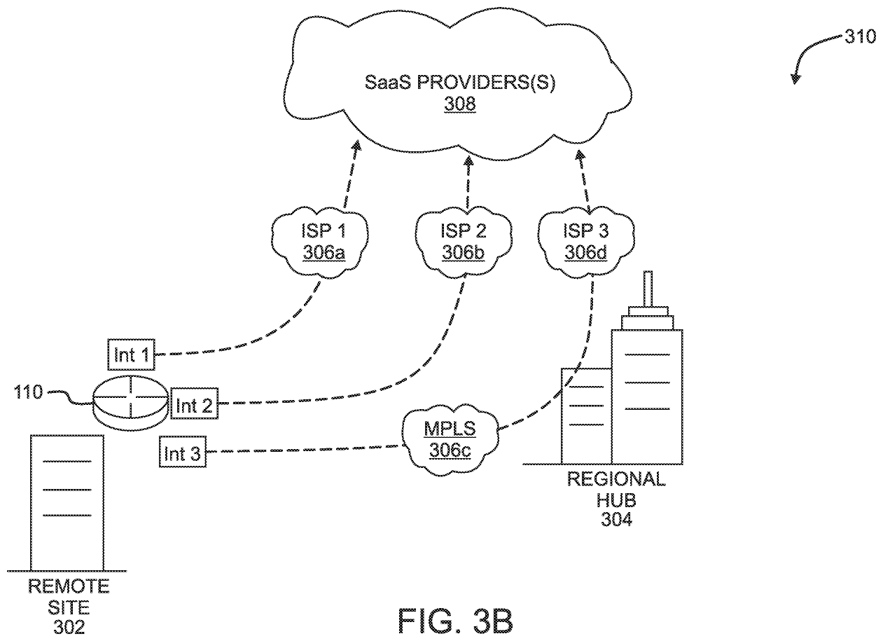

FIGS. 3A-3B illustrate example network deployments (e.g., network deployment 300, network deployment 310, respectively). As shown, a router 110 located at the edge of a remote site 302 may provide connectivity between a local area network (LAN) of the remote site 302 and one or more cloud-based, SaaS providers (e.g., provider(s) 308). For example, in the case of an SD-WAN, router 110 may provide connectivity to SaaS provider(s) (e.g., provider(s) 308) via tunnels across any number of networks 306. This allows clients located in the LAN of remote site 302 to access cloud applications (e.g., Office365™, Dropbox™, etc.) served by SaaS provider(s) (e.g., provider(s) 308).

As would be appreciated, SD-WANs allow for the use of a variety of different pathways between an edge device and a SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., network interfaces 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

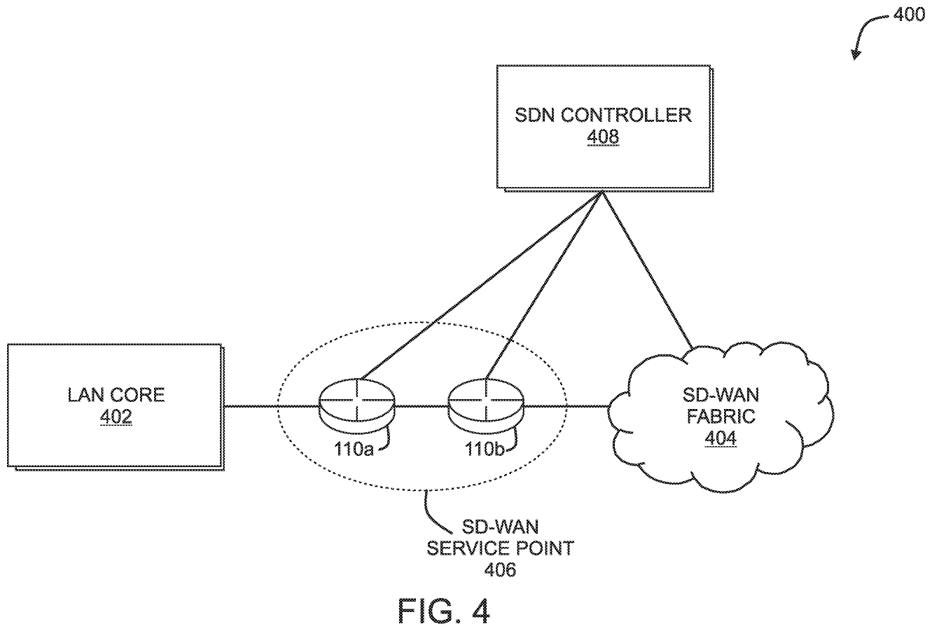

FIG. 4 illustrates an example SDN implementation 400, according to various implementations. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging a SaaS model. Consequently, the number of applications that became network-centric has grown approximately exponentially with the raise of SaaS applications, such as Office365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of service provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various implementations, application aware routing generally refers to the ability to route traffic so as to satisfy the requirements of the application, as opposed to exclusively relying on the (constrained) shortest path to reach a destination IP address. Various attempts have been made to extend the notion of routing, constrained shortest path first (CSPF), link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application.

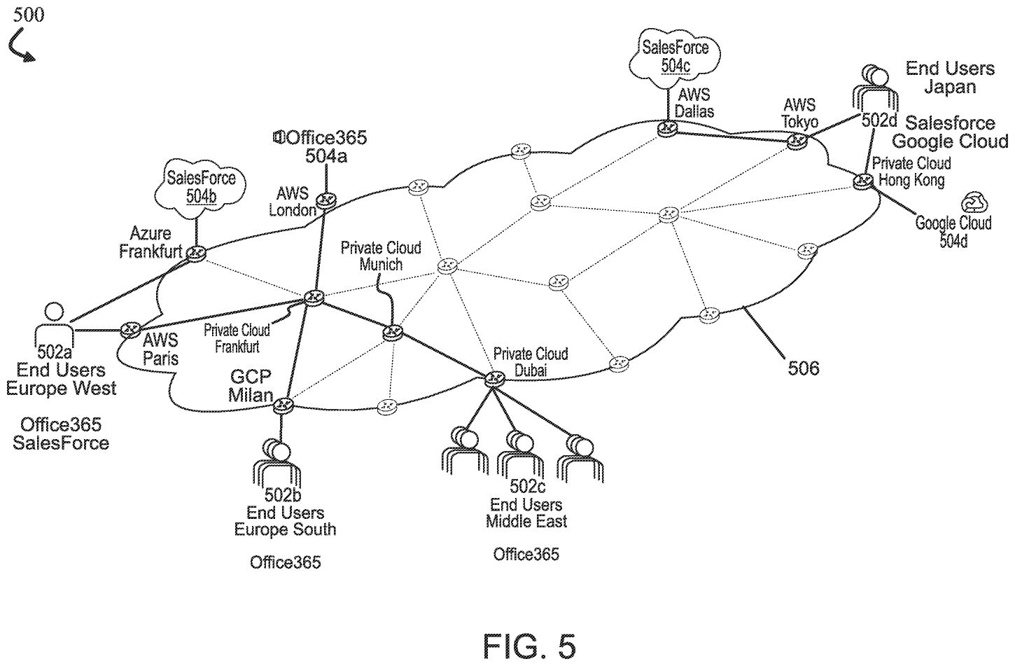

FIG. 5 illustrates an example of a cloud network architecture 500. The cloud network architecture 500 may be a geographically distributed system designed to facilitate communications and interactions among end users 502 (e.g., 502a-502d) and cloud-hosted applications 504 (e.g., 504a-504d) across various locations. Such applications may include a first application 504a (Office365), a second application 504b (e.g., a first instance of Salesforce), a third application 504c (e.g., a second instance of Salesforce), a fourth application 504d (e.g., Google Cloud), etc. Distributed across network 506 may be any number of end users 502 at different locations that access the various instances of the cloud-hosted applications 504. Communication between the end users 502 and the cloud-hosted applications 504, which may be hosted across multiple cloud platforms (e.g., Azure, AWS, Google Cloud, private cloud, etc.), may occur via data communication across network pathways between nodes of network 506.

As noted above, energy and other resource costs have been on the rise, significantly impacting both households and major industries. For instance, electricity prices in some regions have surged by twenty to thirty percent within a year. This increase has been attributed to various factors such as heightened demand and geopolitical issues affecting fuel supplies. Additionally, the energy consumption in key sectors like technology is noteworthy. Data centers, crucial for our digital world, consume about one to two percent of global energy, translating to hundreds of terawatts annually. This amount is only increasing. Furthermore, the telecom industry is also a significant energy consumer. For example, it's estimated that global telecoms use over sixty billion kilowatt-hours of energy per year, a figure that's growing with the expansion of networks like 5G.

The urgency for energy saving is accentuated by both economic and environmental needs. Decreasing energy usage is pivotal in combating climate change, as it reduces the demand for fossil fuels, thereby lessening greenhouse gas emissions. Simple measures like adopting energy-efficient appliances and mindful usage can have profound impacts. For large tech companies and data centers, energy-saving measures are even more crucial due to their high energy demands. The combined efforts of individuals and large enterprises in reducing energy usage can significantly contribute to environmental protection.

“Green IT” is being ushered to the forefront against this backdrop. This approach is exemplified by the practice of using information technology in a way that minimizes environmental impact, emphasizing resource efficiency. For instance, the adoption of energy-efficient servers and optimized data center layouts can markedly reduce energy consumption. In the telecom sector, innovations such as energy-efficient network technologies can substantially cut down power usage. The implementation of Green IT not only aids in environmental conservation but also offers economic benefits through reduced energy costs. By integrating energy-saving measures and Green IT practices, substantial progress can be realized in creating a sustainable and eco-friendly future, addressing both the escalating energy demands and the urgent need to protect our environment.

For example, traditional network designs have approached resource scaling through a traffic engineered network approach or an overprovisioned network approach. The traffic engineered network approach may include operating the network according to the principle that considering a given traffic demand and network capacity, an optimal traffic placement may be found to meet SLAs. This approach is sometimes applied in interior gateway protocol (IGP) traffic engineered (TE) technologies, multiprotocol label switching (MPLS) TE technologies, path computation element (PCE) technologies, etc. The pros of this approach include cost reduction (as compared to over-provisioning) and high SLA/SLO satisfaction. The cons of this approach are that it has high complexity and is inflexible to sudden demand changes.

The overprovisioned network approach may include operating the network according to the principle that network traffic demand can be monitored and the network capacity may be overprovisioned to meet current demands and potential demand fluctuations (e.g., increased demand). This approach is sometimes applied IP with limited IGP-based TE technologies, etc. The pros of this approach include its simplicity. The cons of this approach are that it cannot be sustained in terms of return on investment (ROI) (e.g., issues with over-the-top providers). That is, it is a very costly approach with respect to owning and operating idle capacity out of an abundance of caution.

To summarize, networks have been vastly differing in terms of design principles: some of them have adopted an “over-provisioning” strategy according to which lots of resources are provisioned thus allowing for more simple designs (e.g., no QoS, no complex TE, ease of troubleshooting, etc.). In contrast, other networks have been designed with limited and highly optimized resources, thus requiring the use of more complex technologies to optimize traffic, SLA, and so on. In all cases, current communication networks have traditionally been designed with an “always-on” approach, with network equipment continuously running at full speed/capabilities, resulting in a considerable amount of energy being drained, often unnecessarily in the context of actual demand. Overprovisioning of network equipment (e.g., deploying more, or bigger hardware) in expectation of usage growth down the line, can lead to additional energy wastage until such growth materializes.

However, for most networks, traffic demand is not constant and usually follows daily cyclical patterns with periods of highs and lows (e.g., see network traffic usage time series 600). In enterprise environments, the network is predominantly utilized during traditional 9:00 to 17:00 business hours, with little or no use outside this interval at most locations. A similar observation can be made in the context of Service Provider Networks, where peak network load is usually in the 17:00 to 22:00 before gradually slowing down over the night.

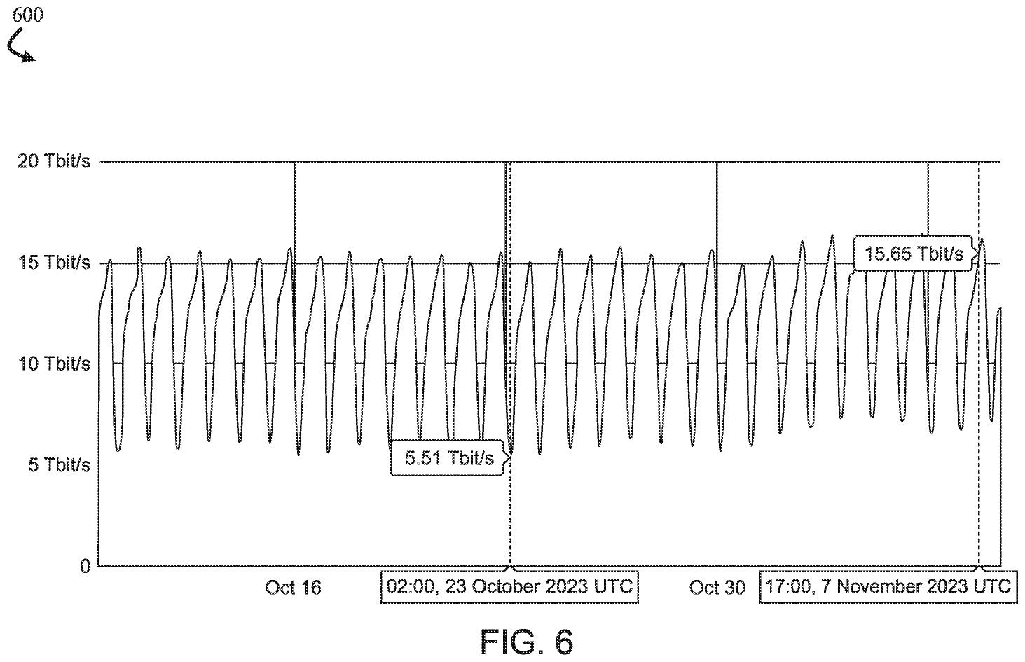

For instance, FIG. 6 illustrates an example of a network traffic usage time series 600. As shown, network traffic usage time series 600 illustrates the fluctuation in network resource demands that cyclically occur over a period of time. In order for networks to accommodate this traffic in a manner that will satisfy SLA requirements, the network must be adequately provisioned with network resources (e.g., computational resources, communication resources, infrastructure, equipment, power, etc.) in a manner than can accommodate cyclical traffic bursts.

The network traffic usage time series 600 may be a DE-CIX Internet Exchange network traffic usage graph illustrating network traffic utilization over a thirty-day period (e.g., Oct. 9, 2023-Nov. 8, 2023). In network traffic usage time series 600, traffic usage cycles between lows of approximately six terabits per second and highs of approximately fifteen terabits per second over twenty-four-hour periods. As can be appreciated from network traffic usage time series 600, the network must be provisioned in order to handle the fifteen terabits per second load. However, the network resources in place to accommodate the fifteen terabits per second load are laying idle and are consequently underutilized when the network is experiencing the six terabits per load.

Facing resource consumption challenges and increasing environmental concerns, organizations of all sizes are now looking for ways to reduce the energy consumption of their communications networks. However, there are no existing mechanisms that can balance resource consumption/conservation with the necessity of SLA/QoE satisfaction.

### ——AI-Driven Elastic Network to Reduce Energy Consumption——

According to various embodiments, the techniques herein allow for the creation of AI-driven elastic networks that are able to reduce energy consumption, while still satisfying the various SLAs of the applications that they support. For simplicity, such a network is also referred to herein as a “GreenNetAI network.” In some aspects, GreenNetAI networks may operate according to the principle that, considering a given traffic demand, the objective is to make the network elastic and reduce energy consumption, while preserving SLAs/QoE and avoiding traffic disruption. More specifically, the introduced GreenNetAI networks may be elastic networks capable of dynamically adapting their network architectures, configurations, equipment, etc. to meet traffic demand in a manner that reduces/minimizes resource consumption, while ensuring little to no traffic disruptions and that their SLAs are satisfied.

As described in greater detail below, a GreenNetAI network may operate by leveraging various mechanisms that can be used at the scale of a large enterprise network, to conserve resources, save energy, reduce costs, reduce greenhouse gas (GHG) emissions, increase operation efficiency, etc. while maintaining Quality of Experience (QoE), according to specific constraints and objectives. This approach operates on the wide range of levers and arbitrage opportunities available in networking. For example, in a given network traffic may still be able to flow through some other path with a worse but still acceptable SLA while some more expensive (e.g., from a resource consumption perspective) devices or paths are powered down. In some instances, these techniques main QoE by making use of digital twins, various models (e.g., for resource consumption), network state retrievals, and/or the monitoring of network QoE and SLA metrics in the form of positive/negative feedback.

Illustratively, the techniques described herein may be performed by hardware, software, and/or firmware, which may include computer executable instructions executed by the processor(s) 220 (or independent processor of network interfaces 210) to perform functions relating to the techniques described herein, such as in conjunction with network optimization process 248.

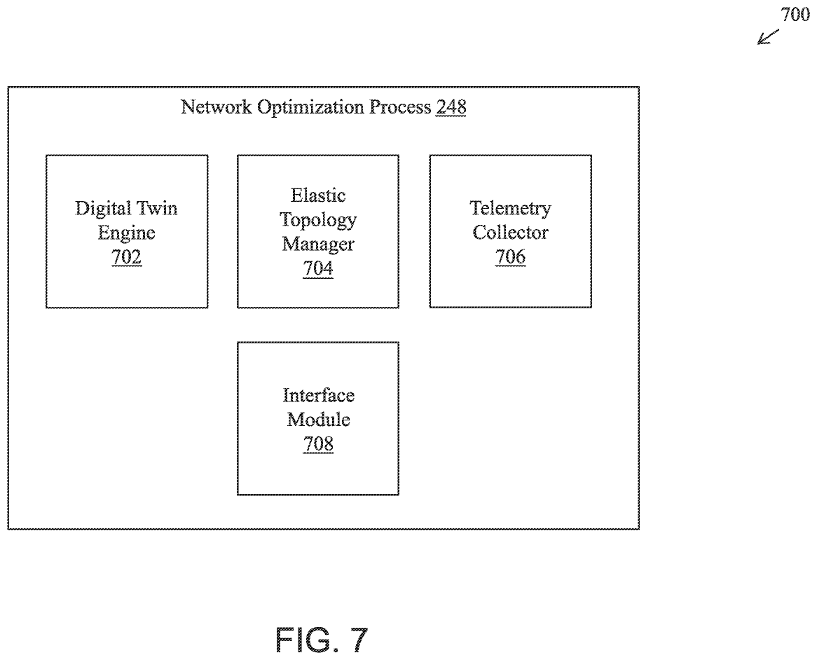

Operationally, FIG. 7 illustrates an example architecture 700 for implementing a GreenAINet network, according to various implementations. At the core of architecture 700 is network optimization process 248, which may be executed by a controller for a network or another device in communication therewith. For instance, network optimization process 248 may be executed by a controller for a network (e.g., SDN controller of an SD-WAN network, a controller of a cloud network, etc.), a particular networking device in the network (e.g., a router, a firewall, etc.), a server, another device or service in communication therewith, or the like.

As shown, network optimization process 248 may include any or all of the following components: a digital twin engine 702, elastic topology manager 704, a quality of telemetry collector 706, and/or an interface module 708. As would be appreciated, the functionalities of these components may be combined or omitted, as desired. In addition, these components may be implemented on a singular device or in a distributed manner, in which case the combination of executing devices can be viewed as their own singular device for purposes of executing network optimization process 248.

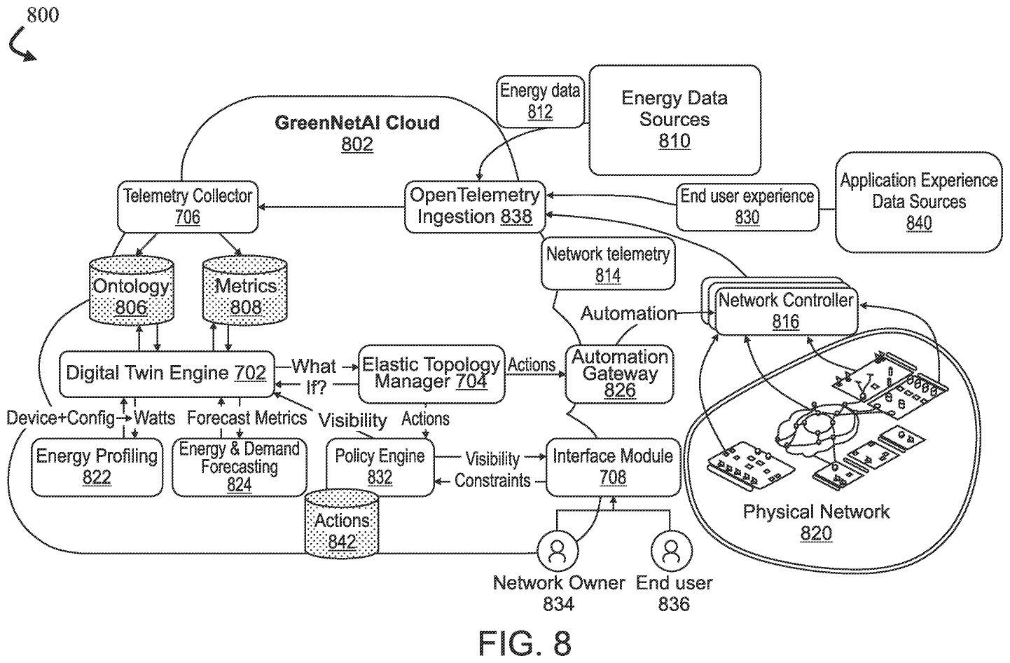

The interactions of the components of architecture 700 are shown in greater detail in FIG. 8 to implement a GreenNetAI cloud 802, in various embodiments. As shown in architecture 800 in FIG. 8, GreenNetAI cloud 802 may exist on top of a physical network 820 controlled by any number of network controllers 816 (e.g., SDN controller 408, etc.).

According to various embodiments, GreenNetAI cloud 802 may rely on a digital twin of physical network 820 to perform its energy-conscious optimizations. To this end, telemetry collector 706 may obtain various information from physical network 820, energy data sources 810, and/or application experience data sources 840, to form a digital twin of physical network 820. In some implementations, telemetry collector 706 may obtain any or all of this information via an OpenTelemetry-based ingestion mechanism 838. However, further implementations provide for telemetry collector 706 doing so by making API calls, accessing one or more data brokers, or the like, either on a pull or push basis.

More specifically, telemetry collector 706 may obtain network telemetry 814 from various entities associated with physical network 820, such as network controllers 816. For instance, network telemetry 814 may include information regarding the state of physical network 820 such as topology information, device information, configuration information, path metrics, routing information, direct energy consumption measurements, or any other information needed from physical network 820 to form a digital twin of physical network 820.

Telemetry collector 706 may also obtain energy data 812 from energy data sources 810. By way of example, energy data sources 810 may include, but are not limited to, services such as Electricity Maps, re.alto, FlatPeak, or the like, that provide energy data 812 (e.g., via various APIs, etc.). In general, energy data 812 may indicate information such as, but not limited to, the energy consumption by the various locations of physical network 820, energy costs, energy demand and supply information, and the like.

Telemetry collector 706 may further obtain QoE telemetry 830 from application experience data sources 840 that is indicative of the experience of an end user, such as end user 836 of the network. For instance, application experience data sources 840 may include services such as ThousandEyes, Nexthink, Aternity, 1E Solutions, Lakeside, or other services that are able to capture digital employee experience (DEX) information that can be included in QoE telemetry 830.

According to various embodiments, network optimization process 248 may represent physical network 820 as a digital twin using the information collected by telemetry collector 706. To this end, network optimization process 248 may rely on two primary building blocks: an ontology 806, stored in a relational database such as EdgeDB or PostgreSQL, and metrics 808, stored in a time-series database such as QuestDB. Generally, ontology 806 maps every network device, user, applications, and flows in physical network 820 to a digital equivalent, stored in database. Meanwhile, metrics 808 may store quantitative, time-varying data corresponding to each entity of ontology 806.

For instance, ontology 806 may represent a router as an entry in a Device table of its underlying database. Each interface of the router is represented in the Interface table, and a relation between them is defined. An application flow originating from a user's laptop, such as end user 836, to an application server in the cloud may be represented in a TrafficFlow table, with relations to both the laptop's and server's entries in an Endpoint table of the database.

A plurality of metrics in metrics 808 may be associated with each such entity in ontology 806. For instance, metrics bytes_per_sec and packets_per_sec can be associated with every entry in the TrafficFlow table. Metrics joule_per_bytes (i.e., traffic-dependent energy consumption) or baseline_power (i.e., baseline energy consumption, even in absence of traffic) can be associated with an interface, a chip, a blade, or an entire device. Physical entities such as routers, switches, and servers may associated with Location entries, for which metrics such as usd_per_watthour and kg_co2_eq_per_watthour, which denote the price in USD per watt hour and the kilograms of Carbon Dioxide (CO2) equivalent of greenhouse gas (GHG) emissions for 1 watt hour, which may be included in energy data 812 from energy data sources 810, which may provide electricity cost and carbon footprint per location across the world. Similarly, metrics 808 may also relate QoE telemetry 830 and/or network telemetry 814 with their corresponding entities in ontology 806.

In various embodiments, digital twin engine 702 may be responsible for reading the data stored in ontology 806 and metrics 808, to perform any or all of the following tasks:
1. Infer missing data: for instance, this may be the case of joule_per_bytes and baseline_power for device components (e.g., interfaces, chipsets, etc.) for which direct power consumption readings are not available. In this case, digital twin engine 702 may make use of an energy profiling module 822 (e.g., a subcomponent of digital twin engine 702) that is configured to estimate the value of joule_per_bytes or baseline_power. Energy profiling module 822 is described in greater detail below.
2. Forecast data: another capability of GreenNetAI cloud 802 is its ability to proactively power on or off some network devices and infrastructure in physical network 820, based on the estimated energy cost, demand, and supply. To this end, digital twin engine 702 may also rely on another subcomponent of it: energy and demand forecasting engine 824.
3. Simulate what-if scenarios: to ensure that any actions taken by GreenNetAI cloud 802 do not inadvertently cause undesired effects, digital twin engine 702 may also leverage a what-if engine subcomponent (not shown) to assess the outcome of a given action, both in terms of the resulting power consumption or carbon footprint, but also in terms of the impact on the end user experience. To do so, digital twin engine 702 must be able to simulate an alternate view of physical network 820 wherein one or more changes have been applied, and infer key metrics of interest (e.g., energy consumption, traffic load, etc.).

In various implementations, elastic topology manager 704 may be responsible for minimizing the energy consumption of physical network 820 (e.g., in terms of GHG emissions, energy costs, power or energy consumption, etc.), given a set of operational constraints, such as maintaining user experience metrics (UEM) above a given threshold for different applications, or limiting the risk of connectivity failure in different scenarios (single/double link/node failures). To this end, elastic topology manager 704 may rely on a subcomponent, policy engine 832, which is responsible for maintaining a set of allowed and disallowed actions 842, based on these constraints. Indeed, depending on the number of users in physical network 820, the types of applications they use, etc., different requirements may be inferred and used to formulate policies for policy engine 832. For instance, banks and hospitals may have very strict operational requirements at the expense of additional energy consumption, whereas retail, entertainment, or smaller businesses may be more flexible in terms of their operational requirements, allowing for even greater reductions in the energy consumption of physical network 820. Policy engine 832 may also provide some visibility as to the constraints during any what-if assessments of potential actions 842.

In various embodiments, elastic topology manager 704 may proceed as follows:
1. Query digital twin engine 702 for the current state of physical network 820, based on its digital twin.
2. Identify saving opportunities (e.g., redundant paths, over-provisioned devices, movable or deferrable workloads) and produce an estimated saving.
3. Simulate the changes using digital twin engine 702 and validate that they remain within operational constraints maintained by policy engine 832 (e.g., link loads below 80%, single-link failure protection).
4. Generate recommendations and or apply the change via an automation gateway 826.

The list of actions 842 triggered elastic topology manager 704 to reduce energy consumption while preserving QoE/DEX can be quite varied. For instance, set of allowed and disallowed actions 842 may include, but are not limited to, the computation of a sub-network for physical network 820, the performance of traffic classification and discrimination in physical network 820, to mention a few.

Automation gateway 826 then translates these changes into API queries to the various controllers. In some instance, automation gateway 826 provides a multi-controller, multi-vendor abstraction over the underlying network controllers 816. Because not all actions 842 may be supported by them, automation gateway 826 may also support a “dry run” mode, which allows elastic topology manager 704 to test whether the changes are possible and adjust the plan, accordingly. In various implementations, automation gateway 826 may be activated by a user or via an automation engine in charge of triggering changes after various verifications.

Here, the optimization of physical network 820 does not involve simply reducing its energy consumption at all cost, but doing so such that the QoE/DEX remains at an acceptable level. To this end, elastic topology manager 704 may also take into account QoE telemetry 830 from application experience data sources 840, to assess the impact of changes made in the past. If any adverse effect is noticed, it may revert the changes and adjust any corresponding operational constraints, accordingly. To do so, energy profiling module 822 may also specify which QoE/DEX metrics should be monitored to reflect the user experience in physical network 820.

Should the QoE/DEX become unsatisfactory (e.g., the required SLA for an application is no longer satisfied), elastic topology manager 704 may also undo any of its implemented actions 842, so as to reverse physical network 820 to its previous network state. In such a case, digital twin engine 702 and elastic topology manager 704 may also adjust their algorithms using detailed information about the stored states of 820 before and after triggering the changes along with the noticed impact on the QoE/DEX. Elastic topology manager 704 may then use this negative information to refine its energy saving optimization and corresponding model(s).

As shown in FIGS. 7-8, network optimization process 248 may also include an interface module 708 that allows interested users such as network owner 834 and/or end user 836 to monitor the on-going status of GreenNetAI cloud 802 and its underlying physical network 820. To this end, interface module 708 may provide a user interface and/or API that allow such a user to:
Visualize the saving opportunities that were captured, and those that were not, either due to limitations of the network (e.g., unsupported actions) or due to operational constraints (e.g., double-link failure protection). These opportunities may be mapped onto the different areas of the network and can be explored either in a table (e.g., ordered by saving magnitude, in USD or kg of Co2-eq) or using a topology visualization.
Provide feedback to the system about potential impacts to the user experience. This can be then used to adjust the operational constraints automatically and/or to improve the internal models used by elastic topology manager 704 to infer the impact of the changes.

### ——Discovery of Power Degraded Modes in a Green Elastic Network——

As noted above, an elastic green network, such as GreenNetAI cloud 802, is able to implement energy-saving actions in the network while ensuring that the network provides acceptable performance. One potential approach to realize energy savings is to configure network equipment to run in so called “power degraded modes” during low utilization periods. This allows them to sacrifice some capabilities by disabling certain software features, running at lower speeds (reduced forwarding capacity) or shutting down various components (shutdown fabrics, redundant components) in order to reduce energy consumption.

However, a challenge to implementing such an approach arises from determining what power degraded modes (power saving capabilities or measures) can be implemented on each device. Modern network environments, such as physical network 820, can be composed of thousands of network devices fulfilling different roles (APs, routers, switches) each with its own set of capabilities. For example, in the case of wireless Access Points (APs), significant energy savings can be achieved by lowering the transmit radio transmit power, disabling some of the transmit streams (2.4 GHz, 5 GHz), or disabling some of the radio antennas altogether. Other measures, such as reducing the frequency of periodic tasks such as channel scan events can help reduce overall CPU load and lead to reduced power consumption. In the case of high-end modular routers or switches, power savings may be achieved by disabling idle fabric components, reducing port speeds or packet forwarding capacity or reducing system redundancy (active-active vs hot standby vs cold standby). Additionally, the effects that each such action may have on the overall system energy consumption are not easy to determine.

Accordingly, the techniques herein further introduce a mechanism that allows for the automated discovery of power-degraded modes in network equipment and quantifies the anticipated energy savings. This is accomplished by integrating with existing network controllers such as DNAC, SD-WAN, Meraki, Application Centric Infrastructure (ACI), or the like, facilitating the analysis of device configuration options, network usage patterns, and energy consumption metrics.

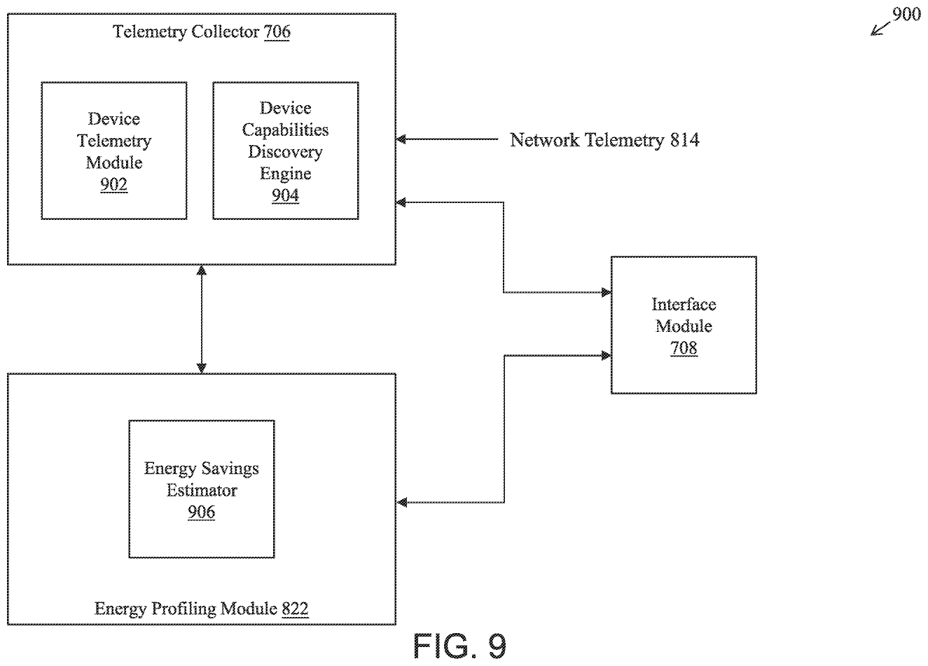

FIG. 9 illustrates an example architecture 900 for the discovery of power degraded modes in a green elastic network. Continuing the example in FIG. 8, the various components of GreenNetAI cloud 802 may operate in conjunction with one another to discover which entities in physical network 820 support power degraded modes and, if so, the extent of energy savings that would result from activating any of those modes on a particular entity. As shown, telemetry collector 706 may include the following sub-components: a device telemetry module 902 and a device capabilities discovery engine 904. In addition, energy profiling module 822 may include an energy savings estimator 906. As would be appreciated, these sub-components may be combined or omitted, as desired. In addition, in cases in which these sub-components are executed in a distributed manner, the executing devices can be seen as a singular device for purposes of the teachings herein.

Further, while architecture 900 is described herein primarily in the context of an elastic green network, such as GreenNetAI cloud 802, further embodiments provide for architecture 900 to be implemented as a standalone service for purposes of discovering the energy-saving capabilities of the devices in a network and reporting on them.

As noted above, telemetry collector 706 may obtain network telemetry 814 from the various entities in physical network 820, either directly, via network controllers 816, and/or via an ingestion mechanism such as OpenTelemetry-based ingestion mechanism 838. More specifically, in various embodiments, device telemetry module 902 may be responsible for integrating with existing network controllers (vManage, DNAC, ACI etc.) and/or network monitoring systems (NMS) to obtain network telemetry 814 such as any or all of the following:
A list of devices that are present in the network (e.g., physical network 820), to construct an inventory of the network.
Device type: model, hardware components, ports, etc. of each device.
Device configuration: currently enabled features and functionality.
Device usage statistics: active users, network traffic usage, CPU and memory utilization statistics, etc.
Device power usage statistics.

Device capabilities discovery engine 904 may be responsible for identifying the list of device capabilities and configuration ‘knobs’ that can be enabled/disabled on each device type and which can lead to energy savings. To do so, device capabilities discovery engine 904 can achieve this by leveraging any of a variety of approaches detailed below.

First, device capabilities discovery engine 904 may start by querying a device via an API interface (or its associated network controller, another ingestion pipeline, etc.) for any built-in power consumption modes. Indeed, some types of network devices, such as wireless APs or 5G base stations, may already have several sleep or low power capabilities available. Such power modes correspond to sets of actions that can be implemented on the target device during low utilization periods, in order to conserve energy at the cost of reducing some of its capabilities. For example, activating low power mode on Meraki wireless APs will automatically disable AirMarshal capabilities, reduce the number of transmit streams in 2.4 GHz, and increase the time between channel scan events. These actions combined can significantly reduce the energy consumed by the AP, at the cost of having lower capacity in the 2.4 GHz band and being slower to react to wireless interference events.

However, in many instances, devices may not have built-in power consumption modes. In such cases, device capabilities discovery engine 904 may attempt to discover the list of individual features or capabilities that can be enabled or disabled to conserve energy. In one embodiment, device capabilities discovery engine 904 may leverage a knowledge base, built by networking subject matter experts (SMEs), listing known energy saving measures by device type and cross check which ones can be configured on the target devices. Furthermore, device capabilities discovery engine 904 may group energy saving measures together in multiple categories, facilitating the creation of multiple potential power degraded modes (PDMs) per device, each with its own set of tradeoffs, such as:
Reduced capacity: features related to reducing the device forwarding capacity such as configuring network ports to operate at lower speeds, reducing the forwarding engine CPU clock, disabling some of the wireless transmit streams, or limiting the transmit power.
Reduced capabilities: disable some capabilities (e.g.: disabling 2.4 GHz and 5 GHz Wi-Fi bands)
Reduced redundancy: configuring hardware components such as redundant fabric cards, routing engines or power supplies in cold-standby (shutdown) or warm-standby (sleep) may result in significant energy savings. These lower redundancy modes can lead to longer recovery times in case of failures. However, these may be perfectly acceptable during periods of low utilization.

In another embodiment, device capabilities discovery engine 904 may query a Large Language Model (LLM) trained on a corpus of network related documentation (configuration guides, technical specification documents, etc.) for a list of energy saving measures corresponding to each device type and compile similar PDMs as the one described above.

Energy savings estimator 906 may be responsible for estimating the potential energy savings of configuring the different PDMs on each device in the network where device capabilities discovery engine 904 has identified such capabilities. To do so, energy savings estimator 906 may determine the impact of each power saving measure. Of course, a single PDM can be composed of a collection of power saving measures. In such cases, energy savings estimator 906 may estimate the overall power savings for a specific PDM by adding up the potential savings of each individual power saving measure.

For instance, energy savings estimator 906 may first attempt to assess the energy usage impact of certain capabilities by leveraging the telemetry and configuration information collected by device telemetry module 902. Energy savings estimator 906 then identifies groups of devices where a certain capability is enabled, as well as devices where the same capability is disabled all while the remaining configuration is the same. Next, energy savings estimator 906 may compare power usage telemetry from both groups of devices at similar network utilization levels, to determine the impact of enabling or disabling the specific capability.

In a second step, for capabilities where the configuration and telemetry analysis prove inconclusive, energy savings estimator 906 may schedule an evaluation session on representative devices in the network where the impact of enabling or disabling specific capabilities on energy consumption can be assessed and records the results.

Finally, energy savings estimator 906 may compile the energy saving estimation for specific PDMs on each network equipment and makes the information available to downstream components. For instance, energy savings estimator 906 may make this information available via interface module 708 (e.g., via an API and/or user interface).

By way of example, interface module 708 may display a user interface that allows a network administrator to review the so-called PDM catalogue, which lists the PDMs identified for each device in the network along with the energy saving estimates compiled by energy savings estimator 906. Additionally, the user interface may, for each device and PDM, provide a summary of the impact (e.g., reduced capacity, reduced capabilities, etc.) as well as the change in configuration. Administrators may then opt disable certain PDMs, if they are not desirable, such as due to additional regulatory, business, or technical constraints. They may also do so for a designation and/or time period (e.g., disallowing a PDM in critical locations during office hours).

In some instances, the user interface provided by interface module 708 may also allow a network administrator to schedule the activation of PMDs on individual devices using either a time schedule (e.g.: activation outside business hours) or usage thresholds. In such cases, GreenNetAI cloud 802 may activate those PMDs whenever a specific network utilization KPI threshold is met (e.g., user count, bandwidth usage, number of flows, or the like).

Finally, in addition to the user interface, interface module 708 may also expose a north bound API to integrated with other energy management systems, to dynamically scale down network resources in response to user traffic needs and SLA requirements, with the end goal of reducing the overall energy consumption of the network, such as during periods of low network utilization.

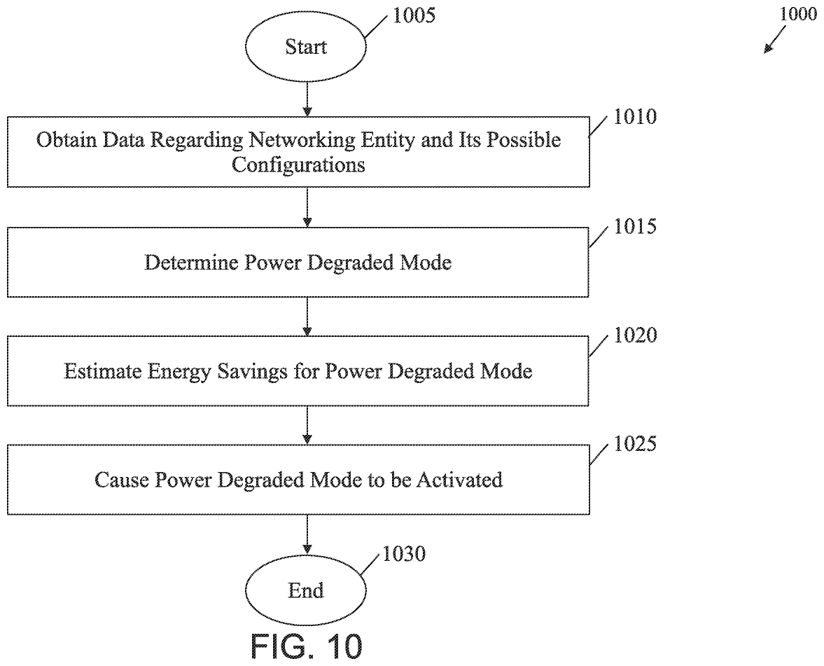

FIG. 10 illustrates an example simplified procedure (e.g., a method) for the discovery of power degraded modes in a green elastic network, in accordance with one or more implementations described herein. For example, a non-generic, specifically configured device (e.g., device 200), such as a router, firewall, controller for a network (e.g., an SDN controller or other device in communication therewith, s cloud controller, etc.), server, or the like, may perform procedure 1000 by executing stored instructions (e.g., network optimization process 248). In some instances, a set of distributed, specifically configured devices may also perform procedure 1000, in which case the set of devices can themselves be viewed as a singular device for purposes of the teachings herein. The procedure 1000 may start at step 1005, and continues to step 1010, where, as described in greater detail above, the device may obtain data regarding a networking entity in a computer network and a set of possible configurations for the networking entity. In some implementations, the device may do so by querying a large language model trained on documentation associated with the networking entity. In other cases, the data regarding the networking entity is obtained from a controller for the computer network. In various instances, the networking entity does not have a built-in sleep mode or a built-in low power mode.

At step 1015, as detailed above, the device may determine a power degraded mode of the networking entity comprising one or more configurations from the set of possible configurations. In some implementations, the one or more configurations disable a redundant hardware component of the networking entity. In further implementations, the networking entity comprises a wireless transceiver, and wherein the one or more configurations disable a wireless band of the wireless transceiver, disable a wireless transmit scream of the wireless transceiver, or reduce a transmit power of the wireless transceiver.

At step 1020, the device may estimate an amount of energy savings associated with activating the power degraded mode of the networking entity, as described in greater detail above. In various implementations, the device may do so by comparing energy consumptions of entities of a same type as the networking entity and with the power degraded mode activated to energy consumptions of entities of the same type as the networking entity and with the power degraded mode deactivated. In some cases, this may entail computing, for each of the one or more configurations, an amount of energy savings.

At step 1025, as detailed above, the device may cause the power degraded mode of the networking entity to be activated based on the amount of energy savings estimated by the apparatus. For instance, the device may provide the amount of energy savings in conjunction with a green elastic network. In such a case, the power degraded mode of the networking entity may be activated based on a prediction that doing so will not decrease performance of the computer network below an acceptable level. In another case, the device may cause activation of the power degraded mode of the networking entity in part by providing an indication of the power degraded mode to a user interface. In such a case, a network administrator may opt to activate the power degraded mode subject to any specified constraints (e.g., location, time, etc.).

Procedure 1000 then ends at step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce approaches for the discovery of power degraded modes in a green elastic network, according to specific constraints and objectives. This approach to maintaining DEX/QoE leverages digital twins, various models (e.g., for energy consumption, etc.), network state retrievals, and/or the monitoring of network QoE and SLA metrics in the form of positive/negative feedback.

According to various embodiments, a method is introduced herein comprising obtaining, by a device, data regarding a networking entity in a computer network and a set of possible configurations for the networking entity. The method may also comprise determining, by the device, a power degraded mode of the networking entity comprising one or more configurations from the set of possible configurations. The method may further comprise estimating, by the device, an amount of energy savings associated with activating the power degraded mode of the networking entity. The method may additionally comprise causing, by the device, the power degraded mode of the networking entity to be activated based on the amount of energy savings estimated by the device.

In some embodiments, the power degraded mode of the networking entity is activated based on a prediction that doing so will not decrease performance of the computer network below an acceptable level. In another embodiment, the one or more configurations disable a redundant hardware component of the networking entity. In another embodiment, the networking entity comprises a wireless transceiver, and wherein the one or more configurations disable a wireless band of the wireless transceiver, disable a wireless transmit scream of the wireless transceiver, or reduce a transmit power of the wireless transceiver. In a further embodiment, obtaining the data regarding the networking entity in the computer network and the set of possible configurations for the networking entity comprises querying a large language model trained on documentation associated with the networking entity. In some embodiments, estimating the amount of energy savings associated with activating the power degraded mode of the networking entity comprises comparing energy consumptions of entities of a same type as the networking entity and with the power degraded mode activated to energy consumptions of entities of the same type as the networking entity and with the power degraded mode deactivated. In some embodiments, comparing the energy consumptions comprises computing, for each of the one or more configurations, an amount of energy savings. In one embodiment, the networking entity does not have a built-in sleep mode or a built-in low power mode. In yet another embodiment, the data regarding the networking entity is obtained from a controller for the computer network. In an additional embodiment, causing the power degraded mode of the networking entity to be activated based on the amount of energy savings estimated by the device comprises providing an indication of the power degraded mode to a user interface.

Further, according to the embodiments herein an apparatus herein may comprise: one or more network interfaces to communicate with a network; a processor coupled to the one or more network interfaces and configured to execute one or more processes; and a memory configured to store a process executable by the processor, the process, when executed, configured to obtain data regarding a networking entity in a computer network and a set of possible configurations for the networking entity. The process when executed is also configured to determine a power degraded mode of the networking entity comprising one or more configurations from the set of possible configurations. When executed, the process is further configured to estimate an amount of energy savings associated with activating the power degraded mode of the networking entity. The process when executed is additionally configured to cause the power degraded mode of the networking entity to be activated based on the amount of energy savings estimated by the apparatus.

According to the embodiments herein, a tangible, non-transitory, computer-readable medium herein may have program instructions stored thereon that, when executed by a device, may cause the computer to perform a method comprising obtaining, by the device, data regarding a networking entity in a computer network and a set of possible configurations for the networking entity. The method may also comprise determining, by the device, a power degraded mode of the networking entity comprising one or more configurations from the set of possible configurations. The method may further comprise estimating, by the device, an amount of energy savings associated with activating the power degraded mode of the networking entity. The method may additionally comprise causing, by the device, the power degraded mode of the networking entity to be activated based on the amount of energy savings estimated by the device.

While there have been shown and described illustrative implementations that provide for the discovery of power degraded modes in a green elastic network, it is to be understood that various other adaptations and modifications may be made within the spirit and scope of the implementations herein. For example, while certain network adaptations are described herein with respect to achieving reduced resource consumption, examples are not limited as such and may involve other modifications, in other implementations. Likewise, a wide variety of resource consumption metrics may be targeted for minimization alongside or instead of those describe herein. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
obtaining, by a device, data regarding a networking entity in a computer network and a set of possible configurations for the networking entity;
determining, by the device, a power degraded mode of the networking entity comprising one or more configurations from the set of possible configurations;
estimating, by the device, an amount of energy savings associated with activating the power degraded mode of the networking entity; and
causing, by the device, the power degraded mode of the networking entity to be activated based on the amount of energy savings estimated by the device.

2. The method as in claim 1, wherein the power degraded mode of the networking entity is activated based on a prediction that doing so will not decrease performance of the computer network below an acceptable level.

3. The method as in claim 1, wherein the one or more configurations disable a redundant hardware component of the networking entity.

4. The method as in claim 1, wherein the networking entity comprises a wireless transceiver, and wherein the one or more configurations disable a wireless band of the wireless transceiver, disable a wireless transmit scream of the wireless transceiver, or reduce a transmit power of the wireless transceiver.

5. The method as in claim 1, wherein obtaining the data regarding the networking entity in the computer network and the set of possible configurations for the networking entity comprises:
querying a large language model trained on documentation associated with the networking entity.

6. The method as in claim 1, wherein estimating the amount of energy savings associated with activating the power degraded mode of the networking entity comprises:
comparing energy consumptions of entities of a same type as the networking entity and with the power degraded mode activated to energy consumptions of entities of the same type as the networking entity and with the power degraded mode deactivated.

7. The method as in claim 6, wherein comparing the energy consumptions comprises:
computing, for each of the one or more configurations, an amount of energy savings.

8. The method as in claim 1, wherein the networking entity does not have a built-in sleep mode or a built-in low power mode.

9. The method as in claim 1, wherein the data regarding the networking entity is obtained from a controller for the computer network.

10. The method as in claim 1, wherein causing the power degraded mode of the networking entity to be activated based on the amount of energy savings estimated by the device comprises:
providing an indication of the power degraded mode to a user interface.

11. An apparatus, comprising:
one or more network interfaces;
a processor coupled to the one or more network interfaces and configured to execute one or more processes; and
a memory configured to store a process that is executable by the processor, the process when executed configured to:
obtain data regarding a networking entity in a computer network and a set of possible configurations for the networking entity;
determine a power degraded mode of the networking entity comprising one or more configurations from the set of possible configurations;
estimate an amount of energy savings associated with activating the power degraded mode of the networking entity; and
cause the power degraded mode of the networking entity to be activated based on the amount of energy savings estimated by the apparatus.

12. The apparatus as in claim 11, wherein the power degraded mode of the networking entity is activated based on a prediction that doing so will not decrease performance of the computer network below an acceptable level.

13. The apparatus as in claim 11, wherein the one or more configurations disable a redundant hardware component of the networking entity.

14. The apparatus as in claim 11, wherein the networking entity comprises a wireless transceiver, and wherein the one or more configurations disable a wireless band of the wireless transceiver, disable a wireless transmit scream of the wireless transceiver, or reduce a transmit power of the wireless transceiver.

15. The apparatus as in claim 11, wherein the apparatus obtains the data regarding the networking entity in the computer network and the set of possible configurations for the networking entity by:
querying a large language model trained on documentation associated with the networking entity.

16. The apparatus as in claim 11, wherein the apparatus estimates the amount of energy savings associated with activating the power degraded mode of the networking entity by:
comparing energy consumptions of entities of a same type as the networking entity and with the power degraded mode activated to energy consumptions of entities of the same type as the networking entity and with the power degraded mode deactivated.

17. The apparatus as in claim 16, wherein the apparatus compares the energy consumptions by:
computing, for each of the one or more configurations, an amount of energy savings.

18. The apparatus as in claim 11, wherein the networking entity does not have a built-in sleep mode or a built-in low power mode.

19. The apparatus as in claim 11, wherein the data regarding the networking entity is obtained from a controller for the computer network.

20. A tangible, non-transitory, computer-readable medium storing program instructions that cause a device to execute a process comprising:
obtaining, by the device, data regarding a networking entity in a computer network and a set of possible configurations for the networking entity;
determining, by the device, a power degraded mode of the networking entity comprising one or more configurations from the set of possible configurations;
estimating, by the device, an amount of energy savings associated with activating the power degraded mode of the networking entity; and
causing, by the device, the power degraded mode of the networking entity to be activated based on the amount of energy savings estimated by the device.
